(19) United States
(12) Patent Application Publication
(10) Pub. No.: US 2007/0074255 A1
(43) Pub. Date: Mar. 29, 2007

(54) SIGNAL RECEIVER, RECEPTION SIGNAL MANAGING METHOD, AND COMPUTER READABLE MEDIUM

(75) Inventor: Yasuhiro MORIOKA, Yokohama-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/470,296

(22) Filed: Sep. 6, 2006

(30) Foreign Application Priority Data
Sep. 29, 2005 (JP) 2005-285595

(51) Int. Cl. H04N 7/18

(52) U.S. Cl. 725/78; 725/81

(57) ABSTRACT

There is a signal receiver including: a plurality of input terminals configured to receive video signals or audio signals from external devices; a connecting unit configured to connect to a first external device via a network; a control signal sending unit configured to send a control signal for changing a signal level of the video signal or the audio signal to the first external device via the network; a detecting unit configured to detect signal levels of the video signals or the audio signals received by the input terminals; a specifying unit configured to specify an input terminal connected to the first external device based on changes of the signal levels of the video signals or the audio signals received by the input terminals; and a storage unit configured to store correspondence between identification information of the first external device and identification information of the input terminal specified.

### CROSS-REFERENCE TO RELATED APPLICATIONS

This application is based upon and claims the benefit of priority from the prior Japanese Patent Applications No. 2005-285595 filed on Sep. 29, 2005, the entire contents of which are incorporated herein by reference.

### BACKGROUND OF THE INVENTION

1. Field of the Invention

The present invention relates to a signal receiver having a plurality of input terminals for receiving a video signal and an audio signal from an external device, a reception signal managing method, and a computer readable medium.

2. Related Art

Although receiving and recording broadcast waves using a video recorder such as a DVD recorder and a video recorder is widely practiced, because of diversification of broadcast systems in recent years, a special external device (tuner) for receiving broadcast waves may be needed aside from the video recorder such as in cases of satellite broadcasting and cable television.

In such a case that an extra external device aside from the video recorder is needed for receiving broadcast waves, a manipulation of an external device for receiving broadcast waves as well as a manipulation of a video recorder itself may be required. For example, when the power of the external device is off, there is a need to manipulate to turn on the external device at first for recording, and when a specified channel is recorded, there is a need to set a channel of the external device so that a broadcast of the specified channel can be received. When a timer recording is set, there is a need to manipulate the external device as well as the video recorder itself for the timer recording. In such a case that there is a need to manipulate the external device as well as the video recorder itself, it is desirable that the manipulation of the external device is automatically performed, for example, in conjunction with the manipulation of the video recorder itself.

For these purposes, a video recorder wherein an external device is automatically manipulated in conjunction with a manipulation of a video recorder itself via a network such as a LAN is disclosed (for example, see JP-A 2004-363649(KOKAI)). The network is capable of two-way communication and connects the video recorder with the external device.

As described above, corresponding to the diversification of broadcast systems in recent years, a video recorder having a plurality of input terminals which receive video and audio signals is prevalent for allowing the video recorder to connect to a plurality of external devices. In the video recorder having a plurality of video and audio signals input terminals, to realize the recording ganged with the external device as described above, the input terminal included in the video recorder which receives video and audio signals and the external device connected with the input terminal need to be associated each other. In other words, the video recorder should be adapted to perform a manipulation for requesting sending of a video or audio signal to the external device via a network capable of two-way communication, to appropriately select an input terminal connected to the external device based on the association between the external device and the input terminal, and to record the video or audio signal received by the input terminal.

Conventionally, such an association between an input terminal of the video recorder and an external device connected to the input terminal needs to be manually done by a user (for example, see JP-A 2002-354351(KOKAI)). However, it is desirable that such association is automatically done by connecting the external device to the video recorder for improving user's convenience.

As described above, according to the conventional art, in the video recorder which can connect to a plurality of external devices via a network capable of two-way communication, there is a problem that an association between a video and audio signals input terminal of a video recorder and an external device connected to the input terminal should be manually done by a user.

### SUMMARY OF THE INVENTION

According to an aspect of the present invention, there is a signal receiver comprising: a plurality of input terminals configured to receive video signals or audio signals from external devices; a connecting unit configured to connect to a first external device via a network capable of interactive communication; a control signal sending unit configured to send a control signal for changing a signal level of the video signal or the audio signal to the first external device via the network capable of interactive communication; a detecting unit configured to detect signal levels of the video signals or the audio signals received by the input terminals; a specifying unit configured to specify an input terminal connected to the first external device based on changes of the signal levels of the video signals or the audio signals received by the input terminals; and a storage unit configured to store correspondence between identification information of the first external device and identification information of the input terminal specified by the specifying unit.

According to an aspect of the present invention, there is a reception signal managing method performed in a signal receiver having a plurality of input terminals for receiving video signals or audio signals from external devices, comprising: connecting to a first external device via a network capable of interactive communication; sending a control signal for changing a signal level of the video signal or the audio signal to the first external device via the network capable of interactive communication; detecting signal levels of video signals or audio signals received by the input terminals; specifying an input terminal connected to the first external device based on changes of signal levels of video signals or audio signals received by the input terminals; and storing correspondence between identification information of the first external device and identification information of the specified input terminal.

According to an aspect of the present invention, there is a computer readable medium storing a computer program for causing a computer having a plurality of input terminals for receiving video signals or audio signals from external devices, to execute instructions to perform steps of: connecting to a first external device via a network capable of interactive communication; sending a control signal for changing a signal level of the video signal or the audio signal to the first external device via the network capable of interactive communication; detecting signal levels of video signals or audio signals received by the input terminals; specifying an input terminal connected to the first external device based on changes of the signal levels of the video signals or the audio signals received by the input terminals; and storing correspondence between identification information of the first external device and identification information of the specified input terminal.

### BRIEF DESCRIPTION OF THE DRAWINGS

FIG. 1 is a diagram which shows a configuration of a video recorder according to an embodiment of the present invention;

FIG. 2 is a diagram which shows a configuration of a home network that includes the video recorder according to an embodiment of the present invention;

FIG. 3 is a diagram which shows a configuration of an external tuner according to an embodiment of the present invention;

FIG. 4 is a diagram which shows an example of a service definition description of a UPnP service for test operation according to an embodiment of the present invention;

FIG. 5 is a diagram which shows an example of a device definition description of a UPnP device according to an embodiment of the present invention;

FIG. 6 is a flowchart which shows a procedure for connecting an external device to a network, according to an embodiment of the present invention;

FIG. 7 is a flowchart which shows a procedure until starting a corresponding input terminal mapping procedure according to an embodiment of the present invention;

FIG. 8 is a flowchart which shows the corresponding input terminal mapping procedure according to an embodiment of the present invention;

FIG. 9 is a flowchart which shows an external device test operation procedure according to an embodiment of the present invention;

FIG. 10 is a flowchart which shows an input terminal state monitoring procedure according to an embodiment of the present invention;

FIG. 11 is a flowchart which shows a state comparative determination procedure according to an embodiment of the present invention;

FIG. 12 is a diagram which shows a connection condition between an external device and an input terminal according to an embodiment of the present invention; and

FIG. 13 is a diagram which shows a configuration of a home network according to an alternative embodiment of the present invention.

### DETAILED DESCRIPTION OF THE INVENTION

Hereinafter, embodiments of the present invention will be described. Although cases wherein a signal receiver according to an embodiment of the present invention is applied to a video recorder which records video or audio are explained below, an object to which a signal receiver according to an embodiment of the present invention may be applied is not limited to the video recorder. For example, the present invention may apply to a signal receiving section of a device such as a TV which has a capability to receive a video signal or an audio signal and display it but which does not have a recording capability.

At first, a network system in home will be described as an environment in which the present embodiment operates. The network system in home includes an external tuner which is an external device connected to the network capable of two-way communication, and a video recorder which is connected to the same network to which the external tuner is connected. Ethernet® is used here as a data communication standard between devices connected to the network. In addition, detection and control of devices on the network are based on UPnP protocol described below. However, a network technology which applies to the present invention is not limited to such a communications standard and a communications protocol, other network technologies such as ECHONET and wireless LAN which allow two-way data communication may be applied to the present invention.

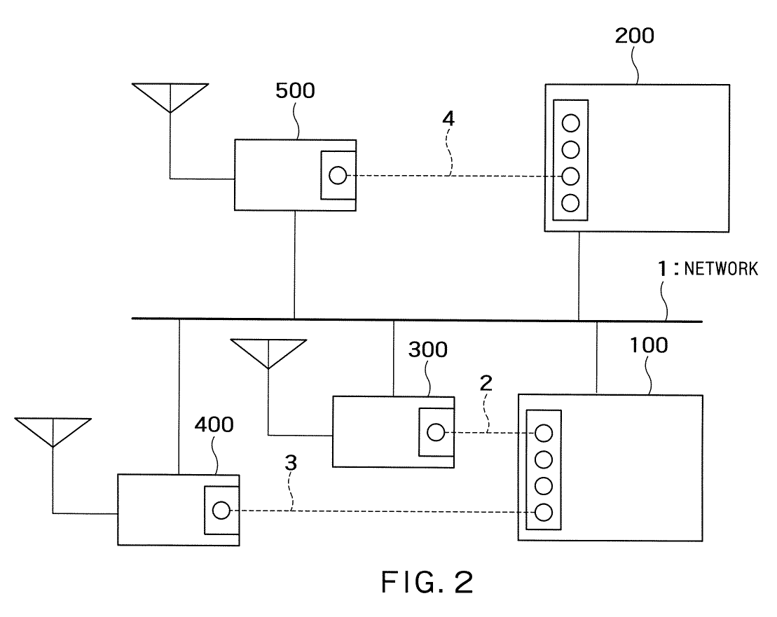

FIG. 2 shows an example of a configuration of a network system in home (home network system) according to the present embodiment. As shown in FIG. 2, a plurality of video recorders and a plurality of external tuners are interconnected through the network. Some of those external tuners and video recorders are connected by a cable (hereinafter referred to as “AV cable”) between an output terminal of the external tuner which outputs a video or audio signal and an input terminal of the video recorder which receives such a signal.

Specifically, a video recorder 100, a video recorder 200, an external tuner 300, an external tuner 400, and an external tuner 500 are connected via a network 1. In addition, the video recorder 100 is connected to the external tuner 300 and external tuner 400 by an AV cable 2 and an AV cable 3 respectively, and the video recorder 200 is connected to the external tuner 500 by an AV cable 4. These AV cables are used for transmitting video signals and audio signals, and not used for two-way data communication.

(Overview of UPnP)

Various standards of home networks for interconnecting devices such as a personal computer in home, a peripheral device thereof, an audio-video device, a telephone, and a household electrical appliance have been proposed so far. Among such home network standards, UPnP (Universal Plug and Play) is a protocol which is built on TCP/IP protocol (for example, see http://www.upnp.org/). As used herein, a device which provides a service through UPnP is called a UPnP device, and a device which uses a service provided from the UPnP device is called a UPnP control point.

When a UPnP control point uses a service from a UPnP device, its procedure includes operations such as detecting the UPnP device, identifying details of the UPnP device, calling a service provided from the UPnP device, and receiving a notification from the UPnP device in sequential order. Then, each operation is realized using an existing Internet standard technology. Specifically, as examples of Internet standard technologies, SSDP (Simple Service Discovery Protocol) is used for detecting a UPnP device, XML (extensible Markup Language) for describing details of UPnP device/service, SOAP (Simple Object Access Protocol) for calling a UPnP service, and GENA (General Event Notification Architecture) for notifying an event. Then, a standard specification of a UPnP device and service is defined for each application.

An embodiment of the present invention which operates in the above environment will be described below.

In the present embodiment, a case wherein a user of a home network illustrated in FIG. 2 newly installs an external tuner is described. An external tuner 300 is an external tuner to be newly installed here. The user connects an output terminal of the external tuner 300 to one of input terminals of a video recorder 100 through an AV cable 2, and also connects the external tuner 300 to a network 1.

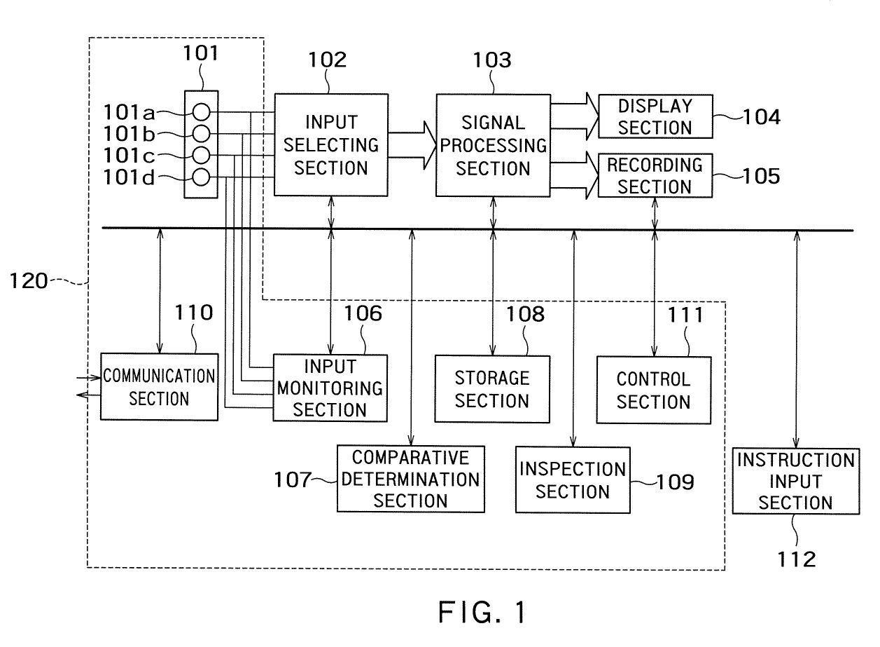

FIG. 1 is a diagram which shows a configuration of a video recorder 100 including a signal receiver 120 according to the present embodiment.

The video recorder 100 according to the present embodiment includes a signal receiving section 101, an input selecting section 102, a signal processing section 103, a display section 104, a recording section 105, an input monitoring section 106, a comparative determination section 107, a storage section 108, an inspection section 109, a communication section 110, a control section 111, and an instruction input section 112. The communication section 110 corresponds to, for example, a connecting section and a control signal sending section. The inspection section 109 corresponds to, for example, a detecting section and an obtaining section. The comparative determination section 107 corresponds to, for example, a specifying section.

The signal receiving section 101 includes a plurality of input terminals for receiving a video signal or an audio signal from the external tuner. As illustrated in FIG. 1, the signal receiving section 101 may include four input terminals (an input terminal 101a, an input terminal 101b, an input terminal 10c, and an input terminal 101d). Then, a video signal to be inputted may be include a composite video signal, an S-video signal, an RGB video signal, or the like. On the other hand, an audio signal to be inputted may be include an analog stereo or monaural signal, or the like.

The input selecting section 102 selects one input terminal from a plurality of input terminals included in the signal receiving section 101, and feed a video signal or an audio signal received at the input terminal to the signal processing section 103.

The signal processing section 103 converts an input signal received from the input selecting section 102 to a video or audio signal whose type can be processed by the display section 104 or the recording section 105 of a subsequent stage.

The display section 104 displays a video or audio signal converted at the signal processing section 103. Additionally, the recording section 105 stores the video or audio signal converted at the signal processing section 103 into a predetermined recording medium. The display section 104 may be included in the video recorder 100 or may be an external device such as a TV connected to the video recorder 100. As the recording medium in which a video or audio signal is stored at the recording section 105, for example, video, DVD, CD, or hard disk may be applied.

The input monitoring section 106 detects a signal level of a signal that is inputted to each input terminal of the signal receiving section 101. As used herein, a signal level detected at the signal processing section 106 refers to a power, an amplitude, or frequency of the signal that is inputted to each input terminal. Detection of the signal level may be performed periodically at a predetermined cycle or may be performed on any timing in accordance with an instruction from the control section 111 as described below. In addition, detection of the signal level may be performed at the same time for all input terminals or may be performed sequentially for each input terminal. A signal level thus obtained at the input monitoring section 106 is associated with a time at which its signal level is detected for each input terminal, and then stored in an input terminal state history table 108a of the storage section 108. More particularly, a time, an identification of an input terminal, type of a signal level (for example, power), and a value of the signal level are associated and stored in the table.

Additionally, in the storage section 108, an external device table 108b, an external device/input terminal correspondence table 108c, and a test operation history table 108d are stored.

The external device table 108b is a list of external devices which include external tuners to which the video recorder 100 can communicate via the network 1. Specifically, it stores identification information for identifying an external device. The external device/input terminal correspondence table 108c is a list of correspondences between each input terminal and an external device connected therewith. Specifically, an identification of the input terminal and an identification of an external device connected to the input terminal are associated and stored in the table. In addition, when an external device connected to an input terminal is unknown, information which denotes “unknown” or “unassigned” is stored for the input terminal. The test operation history table 108d is a list of operations for an external device via the network 1. Specifically, a time of an operation, an identification of an operated external device, and details of the operation are associated and stored in the table.

The comparative determination section 107 refers to the input terminal state history table 108a and the test operation history table 108d of the storage section 108, and compares a history of operations for external tuners and a history of input terminal states, for each external tuner or each input terminal to specify an input terminal to which each external tuner is connected. Then, identifications of the external tuners and identifications of input terminals specified are associated and stored in the external device/input terminal correspondence table 108c.

The inspection section 109 refers to the external device/input terminal correspondence table 108c and the external device table 108b and operates an external tuner whose corresponding input terminal connected therewith is unknown for testing the external tuner via the network. Specifically, a control signal for changing a signal level of a video signal or an audio signal outputted from an external tuner such as a control signal for switching on/off power or for changing a channel of a video signal or an audio signal to be outputted is sent to the external tuner.

The communication section 110 is an interface which sends and receives data to/from an external device including an external tuner via the network 1.

The instruction input section 112 is a part into which a user enters an instruction to manipulate the video recorder 100, and includes, for example, a button, a remote control, and so on.

Then, each of operations of these sections is controlled by the control section 111 which controls all operations of the video recorder 100. In addition, a control program used at the control section 111 has been stored in the storage section 108.

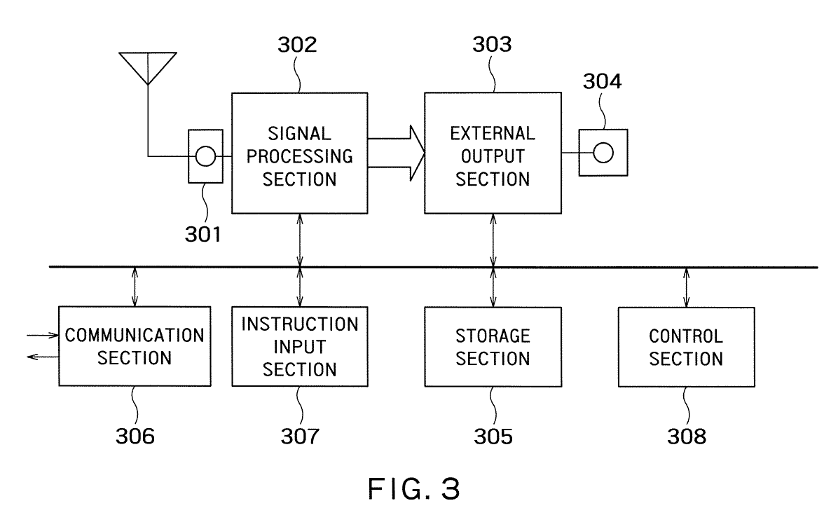

FIG. 3 is a block diagram of an embodiment of an external tuner 300 newly connected to the video recorder 100 according to the present embodiment. As shown in FIG. 3, the external tuner 300 includes an antenna input terminal 301, an signal processing section 302, an external output section 303, an external output terminal 304, a storage section 305, a communication section 306, an instruction input section 307, and a control section 308.

The antenna input terminal 301 is connected to an external antenna. The antenna input terminal 301 is a terminal for inputting signals such as broadcast waves received at the antenna.

The signal processing section 302 selects a broadcast wave specified by a user from broadcast waves received via the antenna input terminal 301, and then converts the selected wave to a video or audio signal whose type is suitable to be outputted to the outside.

The external output section 303 outputs the visual or audio signal converted by the signal processing section 302 through the external output terminal 304.

The communication section 306 is an interface for communicating with other external tuners or video recorders via the network 1.

The instruction input section 307 is a part into which a user enters an instruction to manipulate the external tuner 300, and includes, for example, a button, a remote control, and so on.

Then, each of these sections is controlled by the control section 308 which controls all operations of the external tuner 300. In addition, a control program used at the control section 308 has been stored in the storage section 305.

The configurations of the video recorder 100 and the external tuner 300 connected therewith according to the present embodiment have been described above.

The details of the operations of the video recorder 100 according to the present embodiment now will be described.

As described above, in the present embodiment, it is assumed that UPnP protocol is used for a communication between the video recorder 100 and the external tuner 300. Then, in operation of the video recorder 100 according to the present embodiment, the video recorder 100 acts as a UPnP control point and the external tuner 300 acts as a UPnP device.

At first, a UPnP service for test operation which the external tuner 300 provides and which is used by the video recorder 100 will be defined below. Then, it is assumed that the UPnP service for test operation works on the external tuner 300.

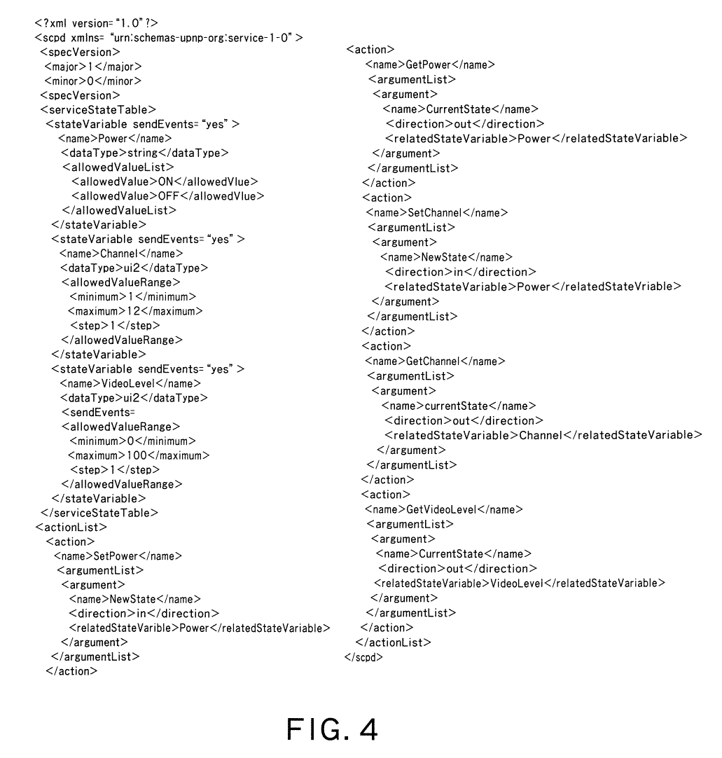

FIG. 4 is an example of a service definition description of the UPnP service for test operation. In the example of the service definition description illustrated in FIG. 4, as state variables, “Power” which indicates an on/off state of a power source of the external tuner 300, “Channel” which indicates a state of selected channel, and “VideoLevel” which indicates a level of a video signal are defined. Then, as operative actions on these states, “SetPower( )” which sets power on/off, “GetPower( )” which gets an on/off state of the power, “SetChannel( )” which sets a channel to be selected, and “GetVideoLevel( )” which gets a level of a video signal are provided to the UPnP control points.

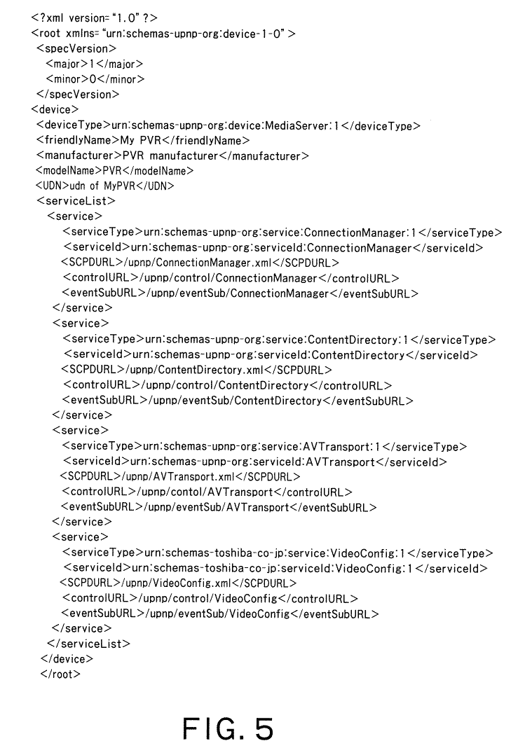

An example of a device definition description of a UPnP device which provides such a UPnP service is shown in FIG. 5. It is assumed that its device type is “urn:schemas-upnp-org:device:MediaServer:1” and therefore “MediaServer device” defined in UPnP-AV specification.

Additionally, in this example, the UPnP service described above is a UPnP service whose service type is identified as “urn:schemas-upnp-toshiba-co-jp:service:VideoConfig:1”, and is listed along with other standard UPnP services of UPnP-AV specification. Thus, a UPnP device having “VideoConfig service” is an external device which needs to be mapped to an input terminal by a signal receiver according to the present embodiment.

The video recorder 100 according to the present embodiment acts as a UPnP control point, and recognizes the existence of device that can be controlled (external tuner 300) on the home network by detecting the UPnP device and service described above on the network. Then, in the present embodiment, an input terminal of the signal receiving section 101 is mapped to the external tuner 300 using a service provided by this external tuner 300.

Hereinafter, as services of the external tuner 300 which the video recorder 100 uses for mapping between an input terminal and the external tuner 300, switching on/off the power of the external tuner 300, changing a channel, getting a level of an output signal from the external tuner 300, or the like as shown in FIG. 4 will be taken for illustrative purposes. However, state variables or actions that can be operated for test other than these services may be defined. For example, an action which can change a brightness or a color balance, or an action which performs a particular pattern of test operation (for example, a pattern that turns power on, sequentially changes a channel selection to be selected, and finally turns power off) may be defined. In other words, since the video recorder 100 according to the present embodiment uses a change of signal level of a video signal or an audio signal inputted from the external tuner 300 for mapping between an input terminal of the video recorder 100 and the external tuner 300, a defined service may be any one which at least changes an output signal of the external tuner 300 in some way.

Then, the video recorder 100 according to the present embodiment operates the external tuner 300 through such actions, and performs mapping between an input terminal of the signal receiving section 101 and the external tuner 300 based on a change of signal level of a signal received at each input terminal.

As an identification of an external tuner to be stored in the external device table 108b or the like, a device identification UDN (UniqueDeviceName) which is utilized in acting as a UPnP device will be used below.

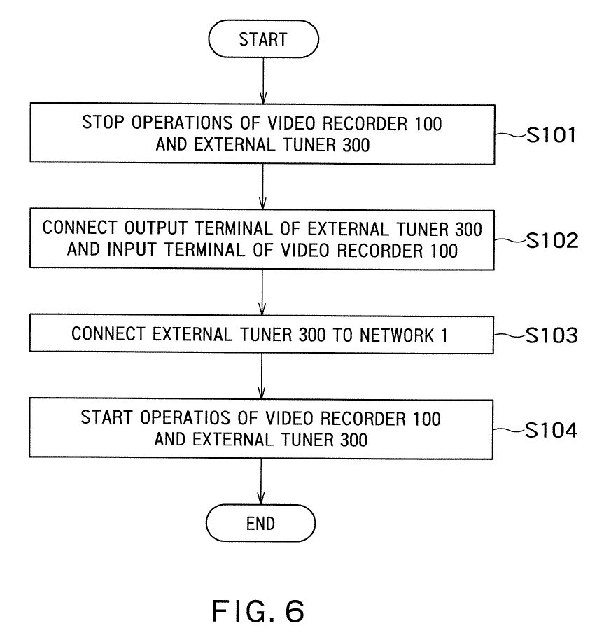

The operations of the video recorder 100 which includes a signal receiver according to the present embodiment will be hereinafter described with reference to flowcharts showed in FIG. 6 to FIG. 11.

At first, a user performs a procedure as shown in a flowchart of FIG. 6.

That is to say, the user turns off powers of the video recorder 100 and the external tuner 300 to stop respective operations (step S101). Next, the user connects the output terminal 304 of the external tuner 300 and any one of input terminals of the signal receiving section 101 in the video recorder 100 through the AV cable 2 (step S102). Then, the user connects the external tuner 300 to the network 1 (step S103). Finally, the user turns on powers of the video recorder 100 and the external tuner 300 to activate each of them (step S104).

Upon activating the video recorder 100 and the external tuner 300 at step S104, their respective communication sections 110 and 306 function so that two-way communication over the network 1 is enabled. As a procedure for enabling a two-way communication over the network, an automated procedure such as DHCP (Dynamic Host Configuration Protocol) or AutoIP may be applied.

Then, mapping between an input terminal of the video recorder 100 and the external tuner 300 is performed. For example, such mapping may be started by an instruction from a user, or may be automatically performed when the video recorder 100 detects an initial activation of the external tuner 300 after installed.

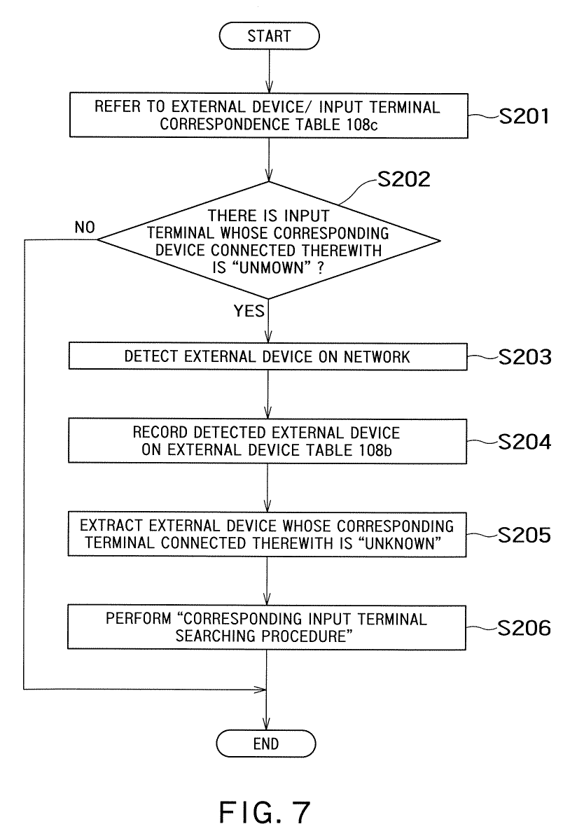

FIG. 7 is a flowchart for describing a mapping operation of the video recorder 100 for mapping between an input terminal of the signal receiving section 101 and the external tuner 300.

At first, the inspection section 109 refers to the external device/input terminal correspondence table 108c stored in the storage section 108 (step S201). Then, it determines whether or not there is an input terminal whose corresponding external device connected therewith is “unknown” (step S202). If there is an input terminal whose corresponding external device connected therewith is “unknown”, then the inspection section 109 detects an external device connected on the network 1 and a service provided by the external device through the communication section 110 (step S203). When an external device(s) is detected on the network 1, information about the detected external device(s) is stored in the external device table 108b of the storage section 108 (step S204).

Then, the inspection section 109 extracts all external devices that appear in the external device table 108b but do not appear in the external device/input terminal correspondence table 108c with reference to the external device table 108b and the external device/input terminal correspondence table 108c (step S205). Then, the inspection section 109 performs a procedure which searches for input terminals corresponding to the extracted external devices (hereinafter referred to as “corresponding input terminal searching procedure”) (step S206).

On the other hand, if there is no input terminal whose corresponding external device connected therewith is “unknown” in the external device/input terminal correspondence table 108c at step S202, the operation ends without performing the subsequent steps.

In the present embodiment, since the external tuner 300 is newly connected to the network 1, the external tuner 300 is detected at step S203 and it is stored in the external device table 108b at step S204. Then, since an input terminal of the video recorder 100 to which the external tuner 300 is connected is still unknown, the external tuner 300 does not appears in the external device/input terminal correspondence table 108c. Therefore, the procedure for searching for an input terminal to which the external tuner 300 is connected is performed at step S206.

Additionally, at step S203, a UPnP service and a UPnP device which provides it are detected by SSDP with a key “serviceType=urn:schemas-toshiba-co-jp:service:VideoConfig:1” in accordance with a procedure for detecting a device or a service in UPnP.

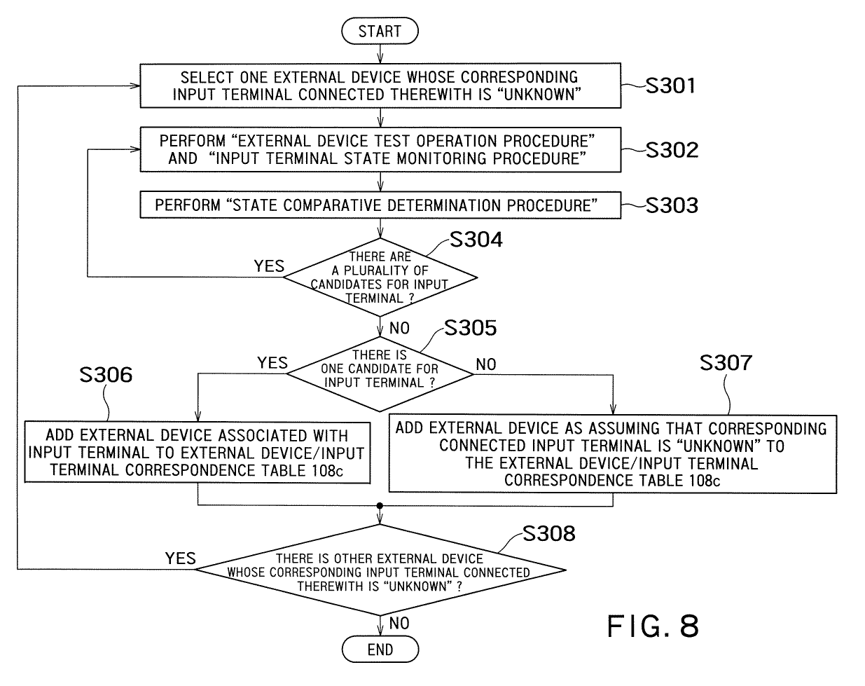

The “corresponding input terminal searching procedure” performed at step S206 now will be described. FIG. 8 shows a flowchart of operations of the video recorder 100 in the “corresponding input terminal searching procedure”.

At first, the inspection section 109 selects one of external devices extracted at the step S205 (step S301). Then, an “external device test operation procedure” and an “input terminal state monitoring procedure” are performed (step S302).

As used herein, “external device test operation procedure” means a procedure for the inspection section 109 to perform a test operation for an external device. Specifically, in this procedure, the inspection section 109 sends a control signal to an external device through the communication section 110 and thereby changes a signal level of a video signal or an audio signal which will be outputted from the external device. On the other hand, “input terminal state monitoring procedure” means a procedure for the input monitoring section 106 to detect a signal level of a signal inputted in an input terminal of the signal receiving section 101. The operations of the video recorder 100 in each of these procedures will be described later in detail.

Then, a “state comparative determination procedure” is performed (step S303). As used herein, “state comparative determination procedure” means a procedure for the comparative determination section 107 to obtain a candidate(s) for an input terminal to which an external device is connected based on a history of operations for the external device performed by the inspection section 109 and a change of signal level detected by the input monitoring section 106. The operations of the video recorder 100 in “state comparative determination procedure” also will be described later in detail.

As a result of “state comparative determination procedure”, if a plurality of candidates are obtained as an input terminal to which the external device selected at step S301 is connected (S304), control returns to step S302 and a test operation different form the test operation previously performed is performed for the external device.

As a result of “state comparative determination procedure”, if only one candidate is obtained as an input terminal to which the external device selected at step S301 is connected (S305), the comparative determination section 107 specifies the obtained candidate for an input terminal as an input terminal to which the external device selected at step S301 is connected, and then adds it to the external device/input terminal correspondence table 108c of the storage section 108 (step S306).

As a result of “state comparative determination procedure”, if no candidate is obtained, the external device selected at step S301 is added to the external device/input terminal correspondence table 108c, setting “unknown” as corresponding connected input terminal associated with the external device (step S307).

The steps as described above are performed for all external devices extracted at step S205 (step S308).

In the present embodiment, an external tuner 300 is selected at step S301, and a test operation on the external tuner 300 is performed at step S302.

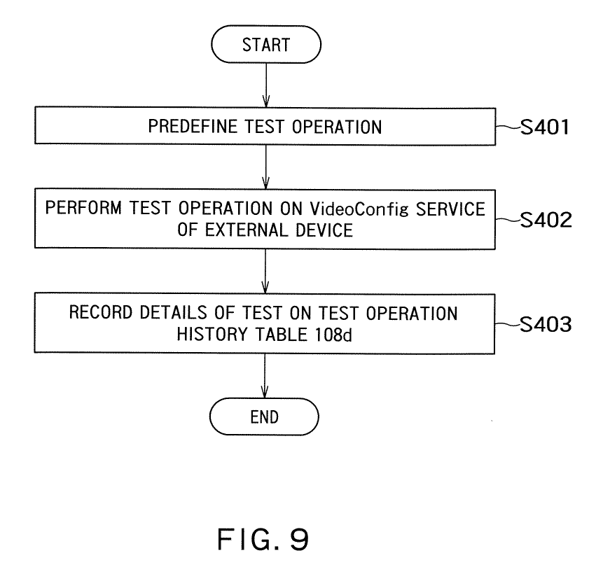

The “external device test operation procedure” performed at step S302 now will be described. FIG. 9 shows a flow chart of operations of the video recorder 100 in the “external device test operation procedure”.

At first, the inspection section 109 predefines a test operation for an external device (step S401). The test operation is an operation for changing a signal level of a video signal or an audio signal outputted from the external device, and is particularly, for example, an operation which switches power on and off repeatedly, an operation which sequentially changes a configurable channel after turning on power and finally turns off power, or the like.

Then, the inspection section 109 performs the test operation on a VideoConfig service of the external device (step S402). The test operation is performed by sending a control signal to the external device. In particular, it may be performed, by calling each action of VideoConfig service of UPnP. That is to say, for example, the operation which switches power on and off repeatedly can be performed by calling “SetPower(ON)” and “SetPower(OFF)” repeatedly, and the operation which sequentially changes a configurable channel after turning on power and finally turns off power can be performed by calling “SetPower(ON)”, calling then “Setchannel( )” within a configurable value of channel, and finally calling “SetPower(OFF)”.

The inspection section 109 stores a history of a test operation in the test operation history table 108d of the storage section 108 each time a test operation is performed (step S403). In storing a test operation, a time when a test operation was performed and its details (for example, “SetPower(ON), “SetPower(OFF), “SetChannel( )”, or the like) may be stored.

The “external device test operation procedure” has been described above.

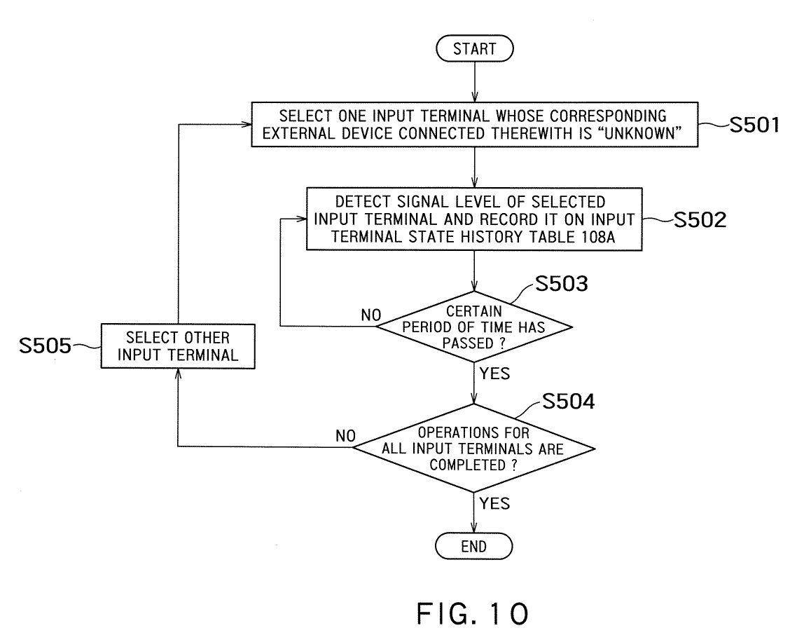

Then, the “input terminal state monitoring procedure” which is performed at step S302 will be described. FIG. 10 shows a flowchart of operations of the video recorder 100 in the “input terminal state monitoring procedure”.

At first, the input monitoring section 106 selects one input terminal whose corresponding external device connected therewith is “unknown” with reference to the external device/input terminal correspondence table 108c stored in the storage section 108 (step S501).

Then, the input monitoring section 106 detects a signal level of a signal inputted to the selected input terminal, and records it on the input terminal state history table 108a of the storage section 108 periodically or each time a change of the signal level is detected (step S502). The input monitoring section 106 continues the above process until a certain period of time passes after a start of the “input terminal state monitoring procedure” (step S503).

When the certain period of time has passed after the start of the “input terminal state monitoring procedure”, the input monitoring section 106 stops detecting a signal level on the input terminal selected at the step S501. Then, the input monitoring section 106 determines whether or not the process described above was performed on all input terminals whose corresponding external terminals connected therewith are “unknown” (step S504). If there is a input terminal on which the process has not been performed yet, the input monitoring section 106 newly selects another input terminal whose corresponding external terminal connected therewith is “unknown” (step S505), and then repeats the process from step S502.

In the procedure described above, it is assumed that the input monitoring section 106 detects a signal level at only one input terminal at the same time. However, when the input monitoring section 106 is capable of detecting signal levels of signals inputted to a plurality of input terminals at the same time, a signal level detected at each input terminal may be stored in the input terminal state history table 108a of the storage section 108 periodically or at each time a change of signal level is detected at each input terminal.

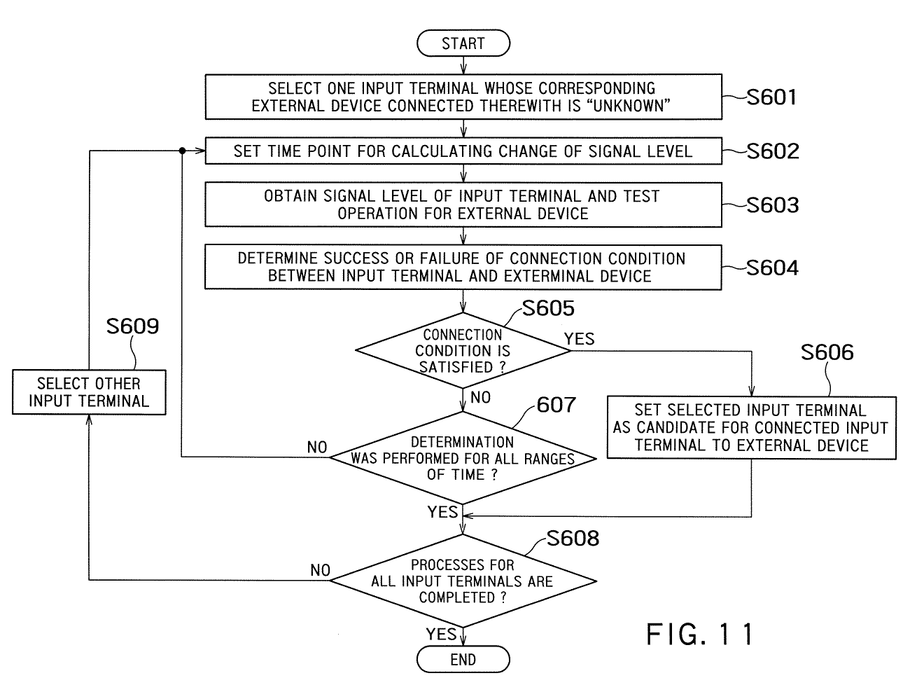

The “state comparative determination procedure” which is performed at step S303 now will be described. FIG. 11 shows a flowchart of operations of the video recorder 100 in the “state comparative determination procedure”.

At first, the comparative determination section 107 selects one input terminal whose corresponding external device connected therewith is “unknown” with reference to the external device/input terminal correspondence table 108c stored in the storage section 108 (step S601).

Then, the comparative determination section 107 sets a time point for calculating a change of signal level detected at the input monitoring section 106 (step S602). A change of signal level is defined as a difference between a signal level at time point “t” and a signal level at time point “t+n” at which a time period “n” has passed from the time point “t”. In addition, ranges of time point “t” and time point “t+n” for a detection of a change of signal level are predefined (T_{MIN}≦t≦T_{MAX}, respMin≦n≦respMax).

The comparative determination section 107 reads signal levels at time point “t” and at time point “t+n” with reference to the input terminal state history table 108a of the storage section 108, and also reads a test operation for an external device performed between time point “t” and time point “t+n” with reference to the test operation history table 108d of the storage section 108 (step S603).

The comparative determination section 107 determines success or failure of a connection condition between the external device for which the test operation was performed and the input terminal, based on the test operation and the change of signal level read at step S603 (step S604). The connection condition will be described later in detail.

When the connection condition is satisfied (step S605), the comparative determination section 107 sets an input terminal that satisfies the connection condition as a candidate for an input terminal to which the external device selected at step S301 is connected (step S606). When the connection condition is not satisfied, ranges of time point “t” and time point “t+n” for a detection of a change of signal level are changed within the above described ranges, and then the process from step S602 will be repeated (step S607).

Then, the comparative determination section 107 determines whether or not the above process was performed for all input terminals whose corresponding external devices connected therewith are “unknown” (step S608). If there is an input terminal on which the process has not been performed yet, the comparative determination section 107 newly selects another input terminal whose corresponding external device connected therewith is “unknown” (step S609) and then repeats the process from step S602.

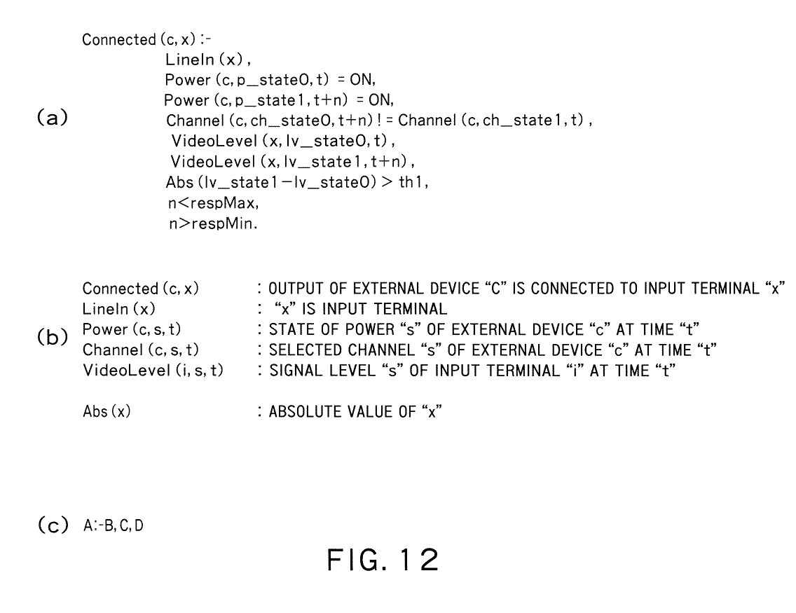

The connection condition between an external device and an input terminal can be determined by solving a constraint expression as shown in FIG. 12(a). In the constrain expression shown in FIG. 12(a), “c” denotes an external device and “x” denotes an input terminal. In addition, each definition of predicate and function is shown in FIG. 12(b). In addition, a conditional expression shown in FIG. 12(c) represents that “A” is valid when conditions “B”, “C”, and “D” are valid at the same time. The connection condition shown in FIG. 12(a) illustrates a case wherein an external device is turned on (“SetPower(ON)”) at first and then a channel of the external device is changed (“SetChannel( )”), as a test operation which changes a signal level of a signal outputted from the external device, in the above “external device test operation procedure” so that an external device is associated with an input terminal depending on the change of signal level.

Thus, the constraint expression shown in FIG. 12(a) represents that it is determined that the external device “c” and the input terminal “x” are connected when all of following conditions are satisfied; (1) the external device “c” is on at time point “t” and time point “t+n”, (2) channels selected by the external device at time point “t” and time point “t+n” are different, (3) Deference between a signal level detected at the input terminal “x” at time point “t” and a signal level detected at the input terminal “x” at time point “t+n” is greater than or equal to a predefined threshold “th1”, and (4) time deference “n” for a comparison of signal level is within the predefined range (respMin≦n≦respMax).

As described above, according to the embodiment of the present invention, automatic mapping between an external tuner 300 and an input terminal to which the external tuner 300 is connected is allowed by performing a test operation through a video recorder 100 for the external tuner 300 connected to the video recorder 100 via a network 1, and then detecting a change of signal level inputted to the input terminal of the video recorder 100.

The signal receiver 120 according to the present embodiment may be implemented by using a general-purpose computer device as a base hardware. Thus, the input selecting section 102, input monitoring section 106, comparative determination section 107, inspection section 109, and control section 111 can be implemented by executing a program by a processor provided in the above computer device. Then, the signal receiver 120 may be implemented by preinstalling the program in the computer device. Or, the signal receiver 120 may be implemented, by storing the program in a storage medium such as a CD-ROM or distributing the program via a network, and by installing the program in the computer device as required. The storage section 108 may be implemented using a memory or a hard disk inside or outside the computer device, or a storage medium such as CD-R, CD-RW, DVD-RAM or DVD-R as required.

While the signal receiver 120 according to the embodiment of the present invention is applied to the video recorder 100 in the embodiment described above, the signal receiver 120 according to the embodiment of the present invention may be applied to a TV having no video recording capability. Even if the signal receiver 120 is applied to such a TV, when the TV includes a plurality of input terminals and each input terminal is connected to different external tuner, the signal receiver 120 according to the embodiment of the present invention may be applied and mapping between an external tuner and an input terminal may be performed automatically thereby allowing manipulation of an external tuner in conjunction with manipulation of the TV. Thus, when the signal receiver 120 according to the embodiment of the present invention previously performs mapping between an external tuner and an input terminal, it is allowed that, for example, if a user selects a channel which needs to be viewed through an external tuner, the external tuner is automatically turned on via a network and video signals and audio signals are sent to the TV via the network.

### Alternative Embodiment 1

According to the embodiment described above, in the “corresponding input terminal searching procedure”, the inspection section 109 selects one external device from a plurality of external devices for performing mapping of input terminals at first, and performs a test operation on the selected external device, and the input monitoring section 106 detects a signal level inputted to each input terminal, and the comparative determination section 107 performs mapping between the external device and an input terminal. On the contrary, it may be allowed that the inspection section 109 selects one input terminal from input terminals of the signal receiver 101 at first, and the input monitoring section 106 performs a test operation on each external device on the network 1 while detecting a signal level inputted to the selected input terminal, and the comparative determination section 107 performs mapping between the external device and an input terminal. In detecting an external device connected to a specific input terminal, the above latter method is effective.

### Alternative Embodiment 2

According to the embodiment described above, values of “respMin” and “respMax” used in the constraint expression which represents a connection condition of step S604 is predetermined. However, a time range from when an external device receives a control signal which instructs a test operation and till when the external device actually acts often varies depending on external devices. Therefore, it is desirable that an external device is able to provide information about a time range when the external device receives a control signal which instructs a test operation and till when the external device actually acts accordingly, and then the information can be used as values of “respMin” and “respMax”.

To realize this, “VideoConfig” service may include, for example, an action “GetResponsibility (stateVariable, oldValue, newValue, min, max)” which provides a maximum time (max) and a minimum time (min) that are required for a state variable (“stateVariable”) such as a state of power (ON/OFF) of an external device to change from one value (“oldValue”) to other value (“newValue”). Then, the maximum time (max) and the minimum time (min) of response time, obtained by the action may be set as “respMin” and “respMax” respectively.

Alternatively, when a response time of each external device is previously known, a relation between an external device and its response time is stored in a sever which is accessible from a video recorder 100 so that “respMin” and “respMax” can be set with reference to the server.

### Alternative Embodiment 3

In the embodiment described above, determination of connection of an external device and an input terminal is performed at step S604 by determining true (connected) or false (non-connected) using the constraint expression shown in FIG. 12(a). Alternatively, the existence of connection of an external device and an input terminal is evaluated in probabilistic manner, for example, based on a deference between signal levels at two time points in the constraint expression shown in FIG. 12(a), and it can be determined that each external device is connected to an input terminal whose probability value is the highest.

### Alternative Embodiment 4

While mapping between an external device and an input terminal is performed at the comparative determination section 107 and its result is automatically stored in the external device/input terminal correspondence table 108c of the storage section 108 in the embodiment described above, a checking procedure may be performed by a user at a time of storing the result in the storage section 108.

In other words, at first, the result is presented to the user when the comparative determination section 107 performs mapping between an external device and an input terminal. In this case, the result may be presented, for example, at the display section 104. Then, the user checks whether or not this mapping is right, and enters its result through the instruction input section 112. A field of “determined” is prepared in the external device/input terminal correspondence table 108c of the storage section 108, and the field is made to be blank until the user finishes the check. Then, the field is made to be “determined” when the user finishes the check.

In addition, when a plurality of input terminals are selected at step S304, its result may be presented to a user and the user may select one input terminal.

### Alternative Embodiment 5

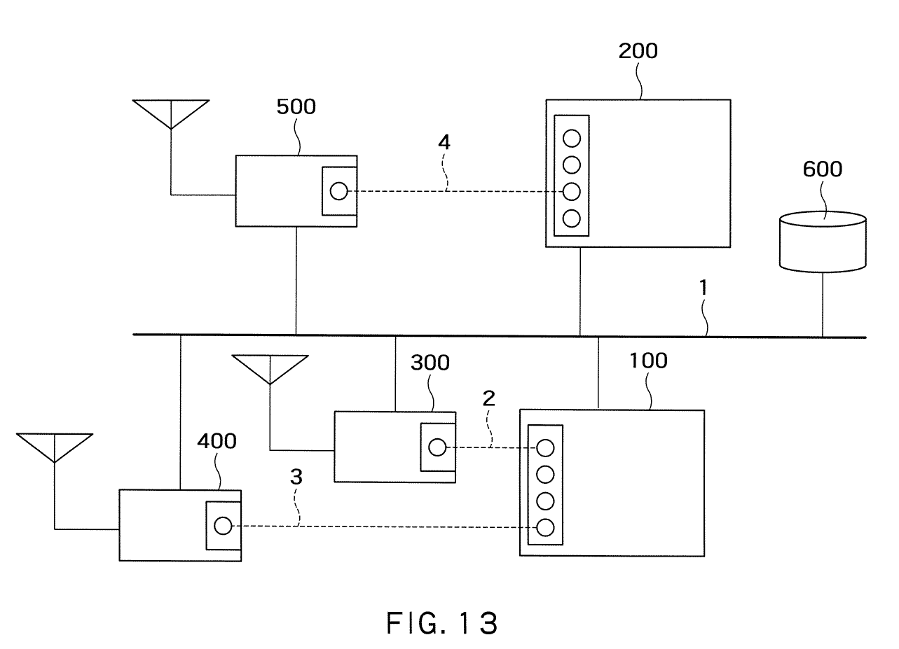

FIG. 13 shows an embodiment which manages an external device/input terminal correspondence table 108c stored in the storage section 108 of the video recorder 100 according to the present embodiment, by a server 600 on a home network. In this way, the server on the home network centrally manages correspondence between an external device and an input terminal of a video recorder, and thereby avoiding that other video recorder performs a test operation for mapping to an input terminal whose mapping has been already completed.

In addition, uniqueness of each input terminal of video recorder can be assured using, as an identification of input terminal, an identification which associates an identification of a video recorder as a UPnP device and an identification of an input terminal in the video recorder.

### Alternative Embodiment 6

In the alternative embodiment 5, as described above, the server 600 on the home network manages the external device/input terminal correspondence table 108c and thereby avoiding that other video recorder performs a test operation for mapping to an input terminal whose mapping has been already performed. A similar advantage is realized by using the video recorder operating as a UPnP device which provides information of mapping between an input terminal and an external device as a UPnP service.

In this case, each video recorder can obtain information of an external device whose mapping has been already completed before mapping between its input terminal and an external device by inquiring information about mapping between an input terminal and an external device of other video recorders, and thereby avoiding a test operation on such an external device. Such an embodiment has an advantage that a server for managing correspondence between an external device and an input terminal is not needed to be prepared.

In addition, the video recorder can provide not only correspondence between an input terminal included in the video recorder and an external device but also correspondence between an input terminal of other video recorders and an external device which is collected as UPnP control points. Therefore, even if there is a video recorder which is not in operation (for example, the video recorder is turned off), correspondence between an input terminal of such a video recorder and an external device can be obtained from other video recorder so that unnecessary test operations can be avoided efficiently.

What is claimed is:

1. A signal receiver comprising:
a plurality of input terminals configured to receive video signals or audio signals from external devices;
a connecting unit configured to connect to a first external device via a network capable of interactive communication;
a control signal sending unit configured to send a control signal for changing a signal level of the video signal or the audio signal to the first external device via the network capable of interactive communication;
a detecting unit configured to detect signal levels of the video signals or the audio signals received by the input terminals;
a specifying unit configured to specify an input terminal connected to the first external device based on changes of the signal levels of the video signals or the audio signals received by the input terminals; and
a storage unit configured to store correspondence between identification information of the first external device and identification information of the input terminal specified by the specifying unit.

2. The signal receiver according to claim 1 wherein the control signal is a control signal which instructs to switch on and off power of the external device.

3. The signal receiver according to claim 1 wherein the control signal is a control signal which instructs to change a channel of the video signal or the audio signal.

4. The signal receiver according to claim 1 wherein a signal level detected by the detecting section is at least one of a power, an amplitude, and a frequency of the video signal or the audio signal.

5. The signal receiver according to claim 1 wherein the specifying section specifies an input terminal connected to the first external device based on the changes of the signal levels of the video signals or the audio signals received by the input terminals within a certain period of time after the control signal has been sent.

6. The signal receiver according to claim 1 further comprising an obtaining section configured to obtain information representing a control action executable by the first external device from the first external device via the network capable of interactive communication;
wherein the control signal sending section sends a control signal corresponding to the control action represented by the obtained information to the first external device via the communicating section.

7. A reception signal managing method performed in a signal receiver having a plurality of input terminals for receiving video signals or audio signals from external devices, comprising:
connecting to a first external device via a network capable of interactive communication;
sending a control signal for changing a signal level of the video signal or the audio signal to the first external device via the network capable of interactive communication;
detecting signal levels of video signals or audio signals received by the input terminals;
specifying an input terminal connected to the first external device based on changes of signal levels of video signals or audio signals received by the input terminals; and
storing correspondence between identification information of the first external device and identification information of the specified input terminal.

8. The method according to claim 7 wherein the control signal is a control signal which instructs to switch on and off power of the first external device.

9. The method according to claim 7 wherein the control signal is a control signal which instructs to change a channel of the video signal or the audio signal.

10. The method according to claim 7 wherein a signal level detected is at least one of a power, an amplitude, and a frequency of the video signal or the audio signal.

11. The method according to claim 7 wherein the specifying the input terminal includes specifying an input terminal connected to the first external device based on the changes of the signal levels of the video signals or the audio signals received by the input terminals within a certain period of time after the control signal has been sent.

12. The method according to claim 7, further comprising,
obtaining information representing a control action executable by the first external device from the first external device via the network capable of interactive communication;
wherein the sending the control signal includes sending a control signal corresponding to the control action represented by the obtained information to the first external device via the network capable of interactive communication.

13. A computer readable medium storing a computer program for causing a computer having a plurality of input terminals for receiving video signals or audio signals from external devices, to execute instructions to perform steps of:
connecting to a first external device via a network capable of interactive communication;
sending a control signal for changing a signal level of the video signal or the audio signal to the first external device via the network capable of interactive communication;
detecting signal levels of video signals or audio signals received by the input terminals;
specifying an input terminal connected to the first external device based on changes of the signal levels of the video signals or the audio signals received by the input terminals; and
storing correspondence between identification information of the first external device and identification information of the specified input terminal.
